(19) United States
(12) Patent Application Publication
(10) Pub. No.: US 2023/0337335 A1
(43) Pub. Date: Oct. 19, 2023

(54) GLASS STRUCTURE AND METHOD OF MANUFACTURING THE SAME

(71) Applicant: AGC Inc., Tokyo (JP)

(72) Inventors: Shunsuke SADAKANE, Tokyo (JP); Kazutoshi TSUGAWA, Tokyo (JP)

(73) Assignee: AGC Inc., Tokyo (JP)

(21) Appl. No.: 18/213,658

(22) Filed: Jun. 23, 2023

Related U.S. Application Data
(63) Continuation of application No. PCT/JP21/33934, filed on Sep. 15, 2021.

(30) Foreign Application Priority Data
Dec. 25, 2020 (JP) 2020-217145

(51) Int. Cl. H05B 3/86; B60J 1/02; B60J 1/08; B60J 1/18; B32B 17/10; B32B 7/02

(52) U.S. Cl. CPC H05B 3/86; B60J 1/02; B60J 1/08; B60J 1/18; B32B 17/10036; B32B 17/10174; B32B 17/10495; B32B 17/10385; B32B 7/02; B32B 17/10807; B32B 17/10761; B32B 2307/7376; B32B 2605/006; B32B 2307/4026

(57) ABSTRACT

A glass structure includes a light shielding treatment glass plate including an optical device mounting region, a light transmitting portion, and a light shielding treatment portion; a light transmissive plate-like member that is thinner than the light shielding treatment glass plate and is mounted on a surface of the light shielding treatment glass plate so as to cover the light transmitting portion and a portion of the light shielding treatment portion; and a conductive pattern film that includes one or more electric heating wires and is formed between the light shielding treatment glass plate and the light transmissive plate-like member. The light transmissive plate-like member is bonded to the light shielding treatment glass plate with a bonding film interposed therebetween, the electric heating wires are formed in the bonding film, and a pair of busbars are formed on a surface of the light shielding treatment glass plate.

### CROSS-REFERENCE TO RELATED PATENT APPLICATIONS

This application is a Bypass Continuation of International Patent Application No. PCT/JP2021/033934, filed on Sep. 15, 2021, which is based upon and claims the benefit of priority from Japanese Patent Application No. 2020-217145, filed on Dec. 25, 2020. The contents of the applications are incorporated herein by reference in their entireties.

### BACKGROUND

The present invention relates to glass structures and methods of manufacturing the glass structures.

In a vehicle, such as an automobile, an optical device that includes an optical instrument, such as a camera, a light detection and ranging (LiDAR), a radar, or an optical sensor, that acquires information about the area ahead of the vehicle to, for example, implement automatic driving or prevent a collision accident, and a housing called, for example, a bracket for housing such an optical instrument may be provided on an inner surface of a windshield.

The housing includes a window portion through which light passes toward the windshield. The portion of the windshield that faces the window portion of the housing of the optical device serves as a light transmitting portion through which light passes, and a light shielding treatment portion subjected to light shielding treatment to prevent unnecessary light from passing is provided to surround the light transmitting portion.

A glass plate to be used for the windshield is preferably a laminated glass that is composed of a plurality of glass plates affixed to each other or a tempered glass. The glass plate can be subjected to light shielding treatment by applying a paste containing black pigment and glass frit to a predetermined region of the glass plate serving as a material for the windshield and by firing the paste to form a light shielding layer. The glass plate subjected to light shielding treatment is thermoformed and processed into a shape having a curved surface.

In a case in which a laminated glass is used as a material for the windshield, the laminated glass may be manufactured by, after forming a light shielding layer on one or more of a plurality of glass plates serving as a material for the laminated glass, affixing the plurality of glass plates to each other, or a light shielding layer may be formed on a surface of a manufactured laminated glass.

In the light shielding treatment glass plate, the light shielding treatment portion having a light shielding layer is comparatively thicker than the light transmitting portion having no light shielding layer. Furthermore, in the thermoforming process, the black light shielding treatment portion absorbs a larger amount of heat than the light transmitting portion and thus has a higher temperature. Owing to these factors, unevenness arises around the border between the light shielding treatment portion and the light transmitting portion in the light shielding treatment glass plate. Such unevenness may cause perspective distortion around the border between the light shielding treatment portion and the light transmitting portion, and this perspective distortion may lead to distortion of an image obtained by the optical device.

For the purpose of solving the problem above, Japanese Unexamined Patent Application Publication No. 2020-131736 discloses a window glass for vehicle provided with an optical device, and in the window glass for vehicle, a light transmissive plate-like member (5) is affixed, by an adhesive (4), to an inner side of a light shielding treatment portion on an inner surface of the window glass for vehicle (claim 1, FIGS. 3A and 3B, etc.).

### SUMMARY

In order to increase the accuracy of sensing by the optical device, electric heating wires or an electric heating film is preferably provided to prevent fogging or freezing on the light transmitting portion of the windshield located forward the optical instrument, such as a camera or a radar, included in the optical device.

International Patent Publication No. WO2014/157535 discloses a window glass for vehicle in which a windshield is constituted by a laminated glass and in which an electric heating film (13) and a pair of busbars (26, 27) for feeding electricity to the electric heating film (13) are formed between a pair of glass plates constituting the laminated glass (claim 1, the section “Description of Embodiments,” FIGS. 1 and 2, etc.).

In the window glass for vehicle described in International Patent Publication No. WO2014/157535, as viewed in a plan view, the electric heating film (13) is formed over substantially the entire surface, and the busbars (26, 27) are formed each in a belt-like shape at the upper end portion and the lower end portion (FIG. 1).

In the technique described in International Patent Publication No. WO2014/157535, the electric heating film is formed over substantially the entire surface of the glass plates serving as a material for the laminated glass constituting the windshield, and the busbars are formed each in a belt-like shape at the upper end portion and the lower end portion. This technique consumes time and cost in forming the electric heating film and the pair of busbars.

Furthermore, with the technique described in International Patent Publication No. WO2014/157535, wires need to be drawn out from the pair of busbars formed inside the laminated glass constituting the windshield and formed, as viewed in a plan view, at the upper and lower end portions of the windshield. In this case, the wires need to be drawn out from the busbars onto the inner surface side or the outer surface side via a side surface of the windshield. Then, the drawing of the wires becomes circuitous, and the appearance is not very aesthetic.

The present invention has been made in view of the circumstances described above and is directed to providing a glass structure with which perspective distortion around a border between a light shielding treatment portion and a light transmitting portion can be suppressed, for which an electric heating wire and a busbar can be formed in a simple manner and at low cost, and that allows for a high flexibility in the design of how a wire is drawn out from the busbar.

The present invention provides a glass structure and a method of manufacturing the glass structure described below.

[1] A glass structure comprising:
a light shielding treatment glass plate including an optical device mounting region on which an optical device is to be mounted, a light transmitting portion that is located within the optical device mounting region and through which light entering the optical device from the outside and/or light emitted from the optical device passes, and a light shielding treatment portion that surrounds at least a portion of the light transmitting portion;
a light transmissive plate-like member that is thinner than the light shielding treatment glass plate and is mounted on a mounting surface for the optical device on the light shielding treatment glass plate so as to cover the light transmitting portion and a portion of the light shielding treatment portion; and
a conductive pattern film including one or more electric heating wires, the conductive pattern film being formed between the light shielding treatment glass plate and the light transmissive plate-like member, wherein
the light transmissive plate-like member is bonded to the light shielding treatment glass plate with a bonding film interposed therebetween,
the electric heating wires are formed in the bonding film, and
a pair of busbars for feeding electricity to the one or more electric heating wires are formed on the mounting surface of the light shielding treatment glass plate.

[2] A method of manufacturing the glass structure of [1], the method comprising:
a step (S11) of preparing a light shielding treatment glass plate with busbars in which the pair of busbars are formed on the light shielding treatment glass plate;
a step (S12) of preparing a resin film with a conductive pattern film in which the conductive pattern film is formed on a resin film for bonding;
a step (S13) of preparing the light transmissive plate-like member; and
a step (S14) of stacking the light shielding treatment glass plate with busbars, the resin film with the conductive pattern film, and the light transmissive plate-like member and bonding the light shielding treatment glass plate with busbars, the resin film with the conductive pattern film, and the light transmissive plate-like member through thermocompression bonding.

[3] A method of manufacturing the glass structure of [1], the light shielding treatment glass plate being a laminated glass having a light shielding layer formed on a portion of an inside and/or a surface thereof, the method comprising:
a step (S21) of preparing a plurality of glass plates having the light shielding layer formed on a portion of a surface of at least one of the plurality of glass plates and having the pair of busbars formed on a surface of one of the plurality of glass plates;
a step (S22) of preparing a resin film with a conductive pattern film in which the conductive pattern film is formed on a resin film for bonding;
a step (S23) of preparing the light transmissive plate-like member; and
a step (S24) of stacking a glass tentative stack obtained by stacking the plurality of glass plates with a resin film for bonding disposed between each glass plate, the resin film with the conductive pattern film, and the light transmissive plate-like member such that the pair of busbars are located at an outermost surface, and bonding the glass tentative stack, the resin film with the conductive pattern film, and the light transmissive plate-like member through thermocompression bonding.

In the glass structure of the present invention, the light transmissive plate-like member that is thinner than the light shielding treatment glass plate is mounted on a mounting surface for an optical device on the light shielding treatment glass plate so as to cover the light transmitting portion and a portion of the light shielding treatment portion. The one or more electric heating wires are formed on this light transmissive plate-like member, and the pair of busbars are formed on the light shielding treatment glass plate.

With the glass structure of the present invention having the configuration described above, perspective distortion around the border between the light shielding treatment portion and the light transmitting portion can be suppressed, the electric heating wires and the busbars can be formed in a simple manner and at low cost, and the manner in which wires are drawn out from the busbars can be designed flexibly.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is an overall plan view of a glass structure of one embodiment according to the present invention;

FIG. 2 is a fragmentary enlarged plan view of FIG. 1;

FIG. 3A is a sectional view, along the line, of a first aspect of the glass structure shown in FIG. 1;

FIG. 3B is a sectional view, along the line, of a second aspect of the glass structure shown in FIG. 1:

FIG. 4A is a schematic sectional view illustrating a method of manufacturing a glass structure of a first embodiment according to the present invention; and

FIG. 4B is a schematic sectional view illustrating a method of manufacturing a glass structure of a second embodiment according to the present invention.

### DESCRIPTION OF EMBODIMENTS

In general, a thin film structure is referred to as “film,” “sheet,” or the like, depending on its thickness. These terms are not differentiated distinctly in the present specification. Accordingly, the term “film” used in the present specification may include “sheet.”

In the present specification, the term “substantially” qualifying a term for a shape indicates that that shape is partially modified as in, for example, a chamfered shape in which a corner of the original shape is rounded, a shape in which a part of the original shape is missing, or a shape in which any small shape is added to the original shape.

In the present specification, unless specifically stated otherwise, the terms “upper and lower,” “right and left,” and “vertical and horizontal” refer to being “upper and lower,” “right and left,” and “vertical and horizontal” in a state in which a glass structure is embedded in a vehicle or the like (state in which the glass structure is in actual use).

In the present specification, unless specifically stated otherwise, the symbol “—” indicating a numerical range means that the numerical values preceding and following that symbol are included as, respectively, the lower limit value and the upper limit value.

Some embodiments of the present invention will be described below.

### [Glass Structure]

A structure of a glass structure of one embodiment according to the present invention will be described with reference to some drawings.

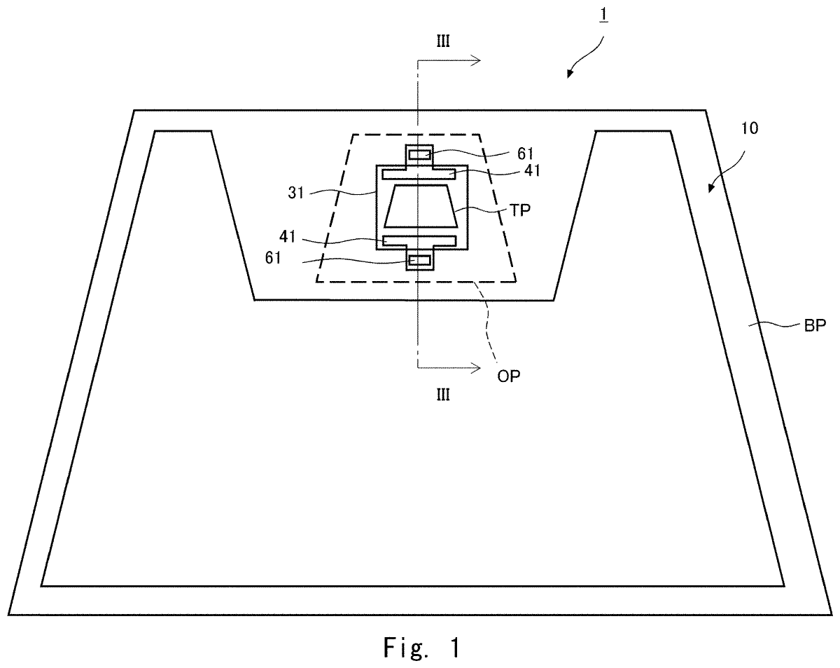

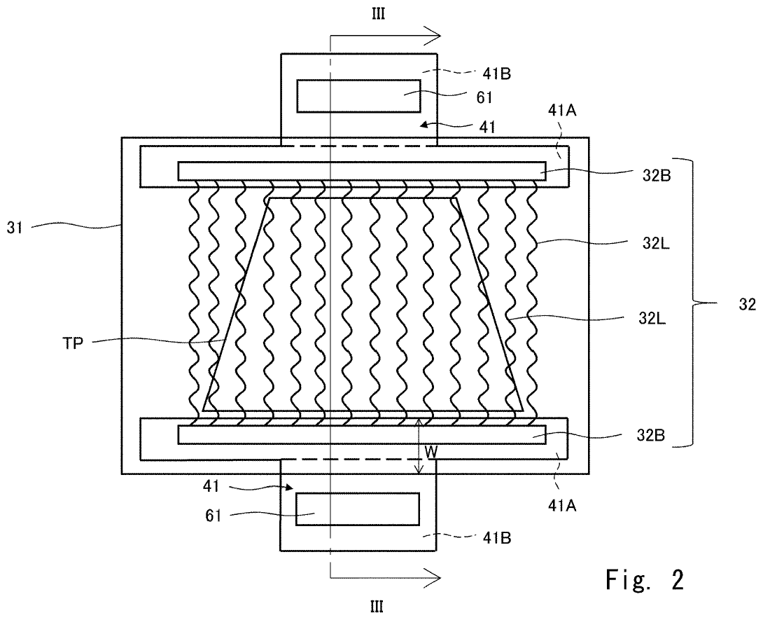

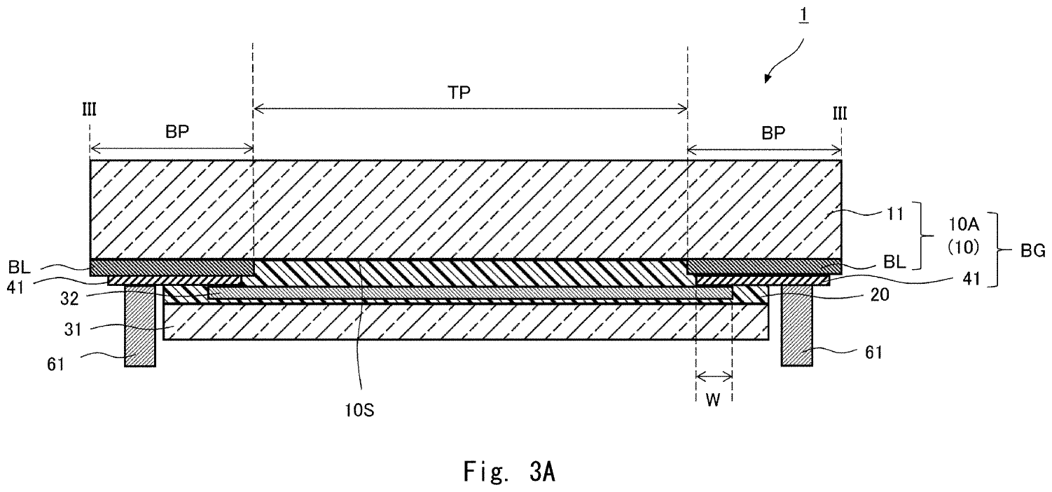

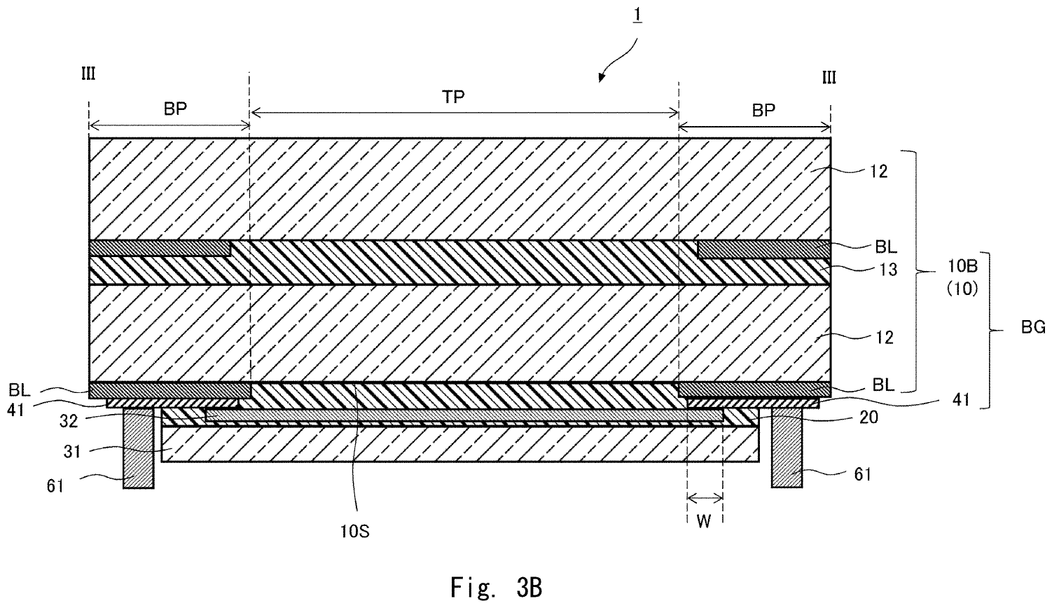

FIG. 1 is an overall plan view of a glass structure of the present embodiment. FIG. 2 is a fragmentary enlarged plan view of FIG. 1. FIGS. 1 and 2 are viewed in perspective. FIG. 3A is a sectional view, along the line, of a first aspect of the glass structure of the present embodiment. FIG. 3B is a sectional view, along the line, of a second aspect of the glass structure of the present embodiment. These drawings are schematic diagrams, and for better viewability, the scales of the constituent elements in the drawings differ, as appropriate, from their actual scales.

As shown in FIG. 1, a glass structure 1 of the present embodiment includes a light shielding treatment glass plate 10, and the light shielding treatment glass plate 10 includes an optical device mounting region OP on which an optical device is to be mounted, a light transmitting portion TP that is located within the optical device mounting region OP and through which light that enters the optical device from the outside and/or light emitted from the optical device passes, and a light shielding treatment portion BP that surrounds at least a portion of the light transmitting portion TP. The light shielding treatment portion BP is a portion subjected to light shielding treatment.

The glass structure 1 of the present embodiment can be preferably applied to, for example, a glass for a vehicle, such as an automobile. The glass structure 1 can be applied to, for example, a windshield, a side window, or a rear window and can be preferably applied to a windshield. The shape of the glass structure 1 can be designed as appropriate, and examples of the shape include a shape in which a plate having a substantially trapezoidal shape as viewed in a plan view is curved generally.

The light shielding treatment glass plate 10 is a glass plate having the light shielding treatment portion BP subjected to light shielding treatment. Examples of a glass plate include a tempered glass, a laminated glass, and an organic glass, and a tempered glass or a laminated glass is preferable.

In a first aspect shown in FIG. 3A, the light shielding treatment glass plate 10 is a light shielding treatment tempered glass 10A in which a light shielding layer BL is formed on a portion of a surface of a tempered glass 11.

The light shielding treatment tempered glass 10A is, after the light shielding layer BL is formed, thermoformed, as necessary, and processed into a shape having a curved surface.

In a second aspect shown in FIG. 3B, the light shielding treatment glass plate 10 is a light shielding treatment laminated glass 10B in which a light shielding layer BL is formed on a portion of the inside and/or a surface of a laminated glass composed of a plurality of glass plates 12 affixed to each other with an intermediate film 13 interposed therebetween. The light shielding treatment laminated glass 10B may be a laminated glass formed by preparing a plurality of glass plates 12 having a light shielding layer BL formed on a portion of a surface of at least one of the plurality of glass plates 12 and by affixing the plurality of glass plates 12 with an intermediate film 13 interposed therebetween or may be a laminated glass formed by forming a light shielding layer BL on a portion of a surface of a laminated glass prepared in advance. In the illustrated example, the light shielding treatment laminated glass 10B is a laminated glass formed by affixing two glass plates 12 each having a light shielding layer BL formed on a portion of its surface with an intermediate film 13 interposed between the two glass plates 12. A laminated glass may include three or more glass plates affixed to each other.

A plurality of glass plates serving as a material for a laminated glass are thermoformed, as necessary, and affixed to each other after having been processed into a shape with a curved surface.

There is no particular limitation on the types of glass plates to serve as a material for a tempered glass or for a laminated glass, and examples include a soda-lime glass, a borosilicate glass, an alumino-silicate glass, a lithium silicate glass, a silica glass, a sapphire glass, and a non-alkali glass.

A tempered glass is a glass formed by subjecting a glass plate of any of those described above to tempering treatment through a known technique, such as an ion exchange technique or an air-cooling tempering technique. For a tempered glass, an air-cooling tempered glass is preferable.

There is no particular limitation on the thickness of a tempered glass, and the thickness is designed in accordance with its intended use. For use as, for example, a windshield, a side window, or a rear window of a vehicle, the thickness is preferably 2-6 mm.

There is no particular limitation on the thickness of a laminated glass, and the thickness is designed in accordance with its intended use. For use as, for example, a windshield, a side window, or a rear window of a vehicle, the thickness is preferably 2-6 mm.

A tempered glass or a laminated glass may have, on at least a portion of the region of its surface, a coating having a function of, for example, repelling water, reducing reflection, reducing radiation, shielding ultraviolet radiation, shielding infrared radiation, or coloring.

A laminated glass may have, on at least a portion of the region of its inside, a film having a function of, for example, reducing reflection, reducing radiation, shielding ultraviolet radiation, shielding infrared radiation, or coloring. At least a portion of the region of an intermediate film in a laminated glass may have a function of, for example, shielding ultraviolet radiation, shielding infrared radiation, or coloring.

An intermediate film in a laminated glass may be a monolayer film or a laminated film.

A laminated glass may include thereinside a film or a device having a function of, for example, emitting light, controlling light, reflecting infrared radiation or visible light, scattering light, absorbing light, or providing decoration.

Examples of a material for an organic glass include an engineering plastic, such as polycarbonate (PC); polyethylene terephthalate (PET); an acrylic resin, such as polymethyl methacrylate (PMMA); polyvinyl chloride; polystyrene (PS); or a combination of any of the above, and an engineering plastic, such as polycarbonate (PC), is preferable.

A light shielding layer BL can be formed through a known method, and for example, a light shielding layer BL can be formed by applying a paste containing black pigment and glass frit to a predetermined region of a surface of a tempered glass 11, of a glass plate 12 serving as a material for a laminated glass, of a laminated glass, or of an organic glass and by heating the paste.

There is no particular limitation on the thickness of a light shielding layer BL, and the thickness is, for example, 5-20 μm.

As shown in FIGS. 1, 3A, and 3B, the glass structure 1 of the present embodiment includes a light transmissive plate-like member 31 that is thinner than the light shielding treatment glass plate 10 and that is mounted on a mounting surface 10S for an optical device on the light shielding treatment glass plate 10 so as to cover the light transmitting portion TP and a portion of the light shielding treatment portion BP.

As shown in FIG. 1, the region of the light shielding treatment portion BP includes a region of the optical device mounting region OP excluding the light transmitting portion TP, or preferably includes a peripheral portion of the glass structure land a region of the optical device mounting region OP excluding the light transmitting portion TP.

An optical device can include, for example, an optical instrument, such as a camera, a light detection and ranging (LiDAR), a radar, or an optical sensor, that acquires information about the area ahead of the vehicle to, for example, implement automatic driving or prevent a collision accident, and a housing called, for example, a bracket for housing such an optical instrument.

The shape of the optical device mounting region OP and the shape of the light transmitting portion TP may each be designed, as appropriate, in accordance with the shape of the optical device, and the optical device mounting region OP and the light transmitting portion TP may each have, for example, a substantially trapezoidal shape or a substantially rectangular shape. The optical device mounting region OP and the light transmitting portion TP may have similar shapes or non-similar shapes. In the illustrated example, the optical device mounting region OP and the light transmitting portion TP each have a substantially trapezoidal shape.

In the illustrated example, the light shielding treatment portion BP surrounds all four sides of the light transmitting portion TP, but it suffices that the light shielding treatment portion BP surround at least a portion of the light transmitting portion TP, and the light shielding treatment portion BP may surround, for example, only three sides of the light transmitting portion TP having a substantially trapezoidal shape or a substantially rectangular shape.

There is no particular limitation on the wavelength range of light that the light transmitting portion TP transmits, and the wavelength range is, for example, a visible light range, an infrared light range, or a visible light to infrared light range.

The plan-view shape of the light transmissive plate-like member 31 can be designed as appropriate, and examples of the plan-view shape include a substantially rectangular shape, a substantially trapezoidal shape, and a combination thereof. The plan-view shape of the light transmissive plate-like member 31 is a substantially rectangular shape in FIG. 1.

The thickness of the light transmissive plate-like member 31 can be designed, as appropriate, within a range that satisfies a condition that the light transmissive plate-like member 31 is thinner than the light shielding treatment glass plate 10. The thickness of the light transmissive plate-like member 31 is preferably 1 mm or less, more preferably 0.8 mm or less, particularly preferably 0.5 mm or less, or most preferably 0.3 mm or less. There is no particular limitation on the lower limit of the thickness of the light transmissive plate-like member 31, and the lower limit is preferably 0.1 mm. When the light transmissive plate-like member 31 is as thin as 1 mm or less in thickness, the light transmissive plate-like member 31 can be made to fit well to the curved surface of the light shielding treatment glass plate 10, and this is preferable.

There is no particular limitation on a material for the light transmissive plate-like member 31, and a glass and/or a resin is preferable. For a glass, a tempered glass, such as a chemical tempered glass, is preferable. Examples of the resin include an engineering plastic, such as polycarbonate (PC); polyethylene terephthalate (PET); an acrylic resin, such as polymethyl methacrylate (PMMA); polyvinyl chloride; polystyrene (PS); or a combination of any of the above, and an engineering plastic, such as polycarbonate (PC), is preferable.

When the light transmissive plate-like member 31 is made of a tempered glass or an engineering plastic, such as polycarbonate, such a light transmissive plate-like member 31 is preferable as it has high flexural rigidity and good heat resistance against the heat from electric heating wires 32L described later.

For use as, for example, a glass for a vehicle, such as an automobile, there is no particular limitation on the radius of curvature of the inner surface (normally, curved concave surface) of the light shielding treatment glass plate 10 and on the radius of curvature of the inner surface (normally, curved concave surface) of the light transmissive plate-like member 31, and these radius of curvature are preferably 1,000-20,000 mm. From the standpoint of suppressing perspective distortion, the difference between the radius of curvature of the inner surface of the light shielding treatment glass plate 10 and the radius of curvature of the inner surface of the light transmissive plate-like member 31 is preferably small.

In the illustrated example, the region for mounting the light transmissive plate-like member 31 is contained within the optical device mounting region OP. Alternatively, the region for mounting the light transmissive plate-like member 31 may extend outside the optical device mounting region OP.

As shown in FIGS. 3A and 3B, the light transmissive plate-like member 31 is bonded to the light shielding treatment glass plate 10 with a bonding film 20 interposed therebetween.

As shown in FIGS. 2, 3A, and 3B, in the glass structure 1 of the present embodiment, a conductive pattern film 32 including one or more electric heating wires 32L is formed between the light shielding treatment glass plate 10 and the light transmissive plate-like member 31. The one or more electric heating wires 32L are formed in the bonding film 20 for bonding the light transmissive plate-like member 31 to the light shielding treatment glass plate 10.

The bonding film 20 is constituted by a resin film. There is no particular limitation on the resin for forming the bonding film 20, and any resin that can bond the light shielding treatment glass plate 10 and the light transmissive plate-like member 31 to each other well may be used. The bonding film 20 preferably includes, for example, one or more types of resins selected from the group consisting of polyvinyl butyral (PVB), ethylene-vinyl acetate copolymer (EVA), cyclo olefin polymer (COP), polyurethane (PU), and an ionomer resin.

The bonding film 20 may include, as necessary, one or more types of additives aside from the resins.

The material for the bonding film 20 is preferably a resin film containing any of the resins listed as examples above, and a commercially available resin film for use as an intermediate film of a laminated glass or a commercially available optical film, for example, can be used.

There is no particular limitation on the thickness of the bonding film 20, and the thickness is, preferably, 0.02-1 mm. When the thickness of the bonding film 20 falls within this range, the light transmissive plate-like member 31 can be bonded well to the light shielding treatment glass plate 10 with the bonding film 20 interposed therebetween, and the perspective distortion of the glass structure 1 can be suppressed effectively.

Commercially available resin films for use as an intermediate film of a typical laminated glass have a thickness of 200-760 μm, and the bonding film 20 formed with use of such a commercially available resin film has a thickness of 190-760 μm. A commercially available optical film (e.g., optical clear adhesive sheet (OCA), etc.) that is thinner than commercially available resin films for use as an intermediate film of a laminated glass may also be used.

In a case in which the light shielding treatment glass plate 10 is a light shielding treatment laminated glass 10B having a light shielding layer BL formed on a portion of its inside and/or its surface, the bonding film 20 preferably has a thickness smaller than the thickness of the intermediate film 13 of the light shielding treatment laminated glass 10B. In FIG. 3B, the intermediate film 13 and the bonding film 20 are depicted thick for better viewability.

When electricity is passed to the electric heating wires 32L, in the bonding film 20, the portion around the electric heating wires 32L has a higher temperature than the remaining portion, and a difference in refractive index is produced between the portion around the electric heating wires 32L and the remaining portion. When this difference in refractive index is large, distortion may arise in an image obtained by an optical device. When the bonding film 20 is designed to have a relatively small thickness, distortion of an image caused by the passing of electricity can be suppressed, and this is preferable.

As shown in FIG. 2, the conductive pattern film 32 includes one or more electric heating wires 32L or preferably includes a plurality of electric heating wires 32L. Furthermore, the conductive pattern film 32 preferably includes one or more electric heating wires 32L and a pair of busbar portions 32B for feeding electricity to the one or more electric heating wires 32L.

As shown in FIGS. 1, 2, 3A, and 3B, a pair of busbars 41 for feeding electricity to the one or more electric heating wires 32L are formed on the mounting surface 10S of the light shielding treatment glass plate 10. In the drawings, the reference character BG refers to a light shielding treatment glass plate with busbars in which the pair of busbars 41 are formed on the light shielding treatment glass plate 10.

In the present embodiment, a portion of each busbar 41 overlaps the light transmissive plate-like member 31, as viewed in a plan view. With this configuration, electricity can be passed with ease between the conductive pattern film 32 and the pair of busbars 41 formed on the light shielding treatment glass plate 10.

As viewed in a plan view, the overlapping width W of each busbar 41 and the conductive pattern film 32 on the light shielding treatment glass plate 10 is not particularly limited, and is preferably 2-15 mm or more preferably 5-10 mm. When the overlapping width W falls within this range, distortion of the light transmissive plate-like member 31 can be suppressed effectively.

In the present embodiment, at least a portion of each of the one or more electric heating wires 32L and/or at least a portion of each of the busbar portions 32B included in the conductive pattern film 32 is in contact with the busbar 41 formed on the light shielding treatment glass plate 10.

When a voltage is applied across the pair of busbars 41 to allow a current to flow in the one or more electric heating wires 32L, fogging or freezing of the glass structure 1 can be prevented.

When the one or more electric heating wires 32L for preventing fogging or freezing are provided in a region that includes the light transmitting portion TP located forward an optical instrument, such as a camera or a radar, included in an optical device, the accuracy of sensing by the optical device can be improved.

There is no particular limitation on the line pattern of each electric heating wire 32L or on the array pattern of the electric heating wires 32L. For example, as shown in FIG. 2, a pattern in which the plurality of electric heating wires 32L each having, for example, a wave line shape or a polygonal line shape as viewed in a plan view are arrayed alongside each other at predetermined intervals and in which these electric heating wires 32L are connected in parallel to the pair of busbars 41 or to the pair of busbar portions 32B is preferable.

A busbar and a busbar portion are referred to collectively below as “busbar (portion).”

The wavelength and/or the period of the electric heating wires 32L may change midway from one busbar (portion) (one electrode) to the other busbar (portion) (the other electrode).

In a case in which the conductive pattern film 32 includes a plurality of electric heating wires 32L, adjacent electric heating wires 32L may be in phase or out of phase within a range from one busbar (portion) (one electrode) to the other busbar (portion) (the other electrode). When adjacent electric heating wires 32L are out of phase, a beam of light caused by regular scattering of light can be suppressed, and this is preferable.

Of the plurality of electric heating wires 32L shown in FIG. 2, two or more electric heating wires 32L may be coupled together.

The shape and the arrangement of the pair of busbar portions 32B or of the pair of busbars 41 can be designed as appropriate.

The pair of busbar portions 32B can be disposed, as viewed in a plan view, outside the light transmitting portion TP so as to face each other with the light transmitting portion TP located therebetween. In this case, the one or more electric heating wires 32L can be heated uniformly with ease, and this is preferable. The pair of busbar portions 32B can be disposed, as viewed in a plan view, outside and to the upper and lower sides or to the right and left sides of the light transmitting portion TP with the light transmitting portion TP located therebetween. The pair of busbar portions 32B are disposed, as viewed in a plan view, preferably symmetrically outside the light transmitting portion TP with the light transmitting portion TP located therebetween. In the illustrated example, the pair of busbar portions 32B are disposed, as viewed in a plan view, symmetrically outside and to the upper and lower sides of the light transmitting portion TP with the light transmitting portion TP located therebetween.

In a similar manner, the pair of busbars 41 can be disposed, as viewed in a plan view, outside the light transmitting portion TP so as to face each other with the light transmitting portion TP located therebetween. In this case, the one or more electric heating wires 32L can be heated uniformly with ease, and this is preferable. The pair of busbars 41 can be disposed, as viewed in a plan view, outside and to the upper and lower sides or to the right and left sides of the light transmitting portion TP with the light transmitting portion TP located therebetween. The pair of busbars 41 are disposed, as viewed in a plan view, preferably symmetrically outside the light transmitting portion TP with the light transmitting portion TP located therebetween.

The conductive pattern film 32 and the pair of busbars 41 are preferably disposed within the optical device mounting region OP, as shown in FIG. 1.

The linewidth, the thickness, and the pitch of the electric heating wires 32L can be designed as appropriate.

From the standpoint of a balance between the transparency and the function of preventing fogging or freezing, the linewidth is preferably 2-150 μm or more preferably 5-50 μm.

From the standpoint of a balance between the transparency and the function of preventing fogging or freezing, the thickness is preferably 0.01-20 μm or more preferably 0.05-10 μm.

From the standpoint of a balance between the transparency and the function of preventing fogging or freezing, the pitch is preferably 1-50 μm or more preferably 2-10 μm.

The plan-view shape of the pair of busbar portions 32B or of the pair of busbars 41 can be designed as appropriate.

The plan-view shape of each busbar portion 32B may be, for example, a line shape, a belt shape, a substantially rectangular shape, a substantially trapezoidal shape, or a combination of any of the above. In the illustrated example, the plan-view shape is a belt shape.

The plan-view shape of each busbar 41 may be, for example, a line shape, a belt shape, a substantially rectangular shape, a substantially trapezoidal shape, or a combination of any of the above. In the present embodiment, a portion of each busbar 41 is located between the light shielding treatment glass plate 10 and the light transmissive plate-like member 31, and the remaining portion of each busbar 41 is located outside the light transmissive plate-like member 31. In the example illustrated in FIG. 2, each busbar 41 is composed of, as viewed in a plan view, a belt-shaped portion 41A and a substantially rectangular-shaped portion 41B. The belt-shaped portion 41A is formed so as to extend below the light transmissive plate-like member 31 and along a side of the light transmissive plate-like member 31, and the substantially rectangular-shaped portion 41B is formed so as to be continuous with the belt-shaped portion 41A and partially located outside the light transmissive plate-like member 31.

In the illustrated example, the conductive pattern film 32 includes the plurality of electric heating wires 32L and the pair of busbar portions 32B. As viewed in a plan view, each individual electric heating wire 32L extends in the top-and-bottom direction, and the pair of busbar portions 32B are disposed symmetrically outside and to the upper and lower sides of the light transmitting portion TP with the light transmitting portion TP located therebetween. The pair of busbars 41 are disposed symmetrically outside and to the upper and lower sides of the light transmitting portion TP with the light transmitting portion TP located therebetween.

As viewed in a plan view, the end portions at the upper side and the lower side of each individual electric heating wire 32L are in contact with the respective busbar portions 32B disposed to the upper side and the lower side with the light transmitting portion TP located therebetween and in contact with the respective busbars 41 disposed to the upper side and the lower side with the light transmitting portion TP located therebetween. As viewed in a plan view, the busbar portions 32B, of the conductive pattern film 32, that are disposed to the upper side and the lower side with the light transmitting portion TP located therebetween are in contact with the respective busbars 41 disposed to the upper side and the lower side with the light transmitting portion TP located therebetween.

The conductive pattern film 32 includes one or more types of conductive materials. Examples of materials for the conductive pattern film 32 include a metal, such as Ag, Au, Cu, Pd, Pt, Ti, Cr, Ni, Al, Zr, W, V, Rh, Ir, or an alloy of any of the above; a metal oxide, such as ZnO, SnO₂, In₂O₃ (ITO), WO₃, Al₂O₃, Ga₂O₅, TiO₂, or Ta₂O₅; or a combination of any of the above. The conductive pattern film 32 may be a laminated film.

There is no particular limitation on the method of depositing the conductive pattern film 32, and examples of the method include a physical vapor deposition (PVD) technique, such as a sputtering technique, a vacuum vapor deposition technique, or an ion plating technique; a chemical vapor deposition (CVD) technique; or a wet coating technique.

Instead of depositing the one or more electric heating wires 32L, one or more commercially available wires may be used as the one or more electric heating wires 32L.

The pair of busbars 41 are each a conductive film that includes one or more types of conductive materials. Examples of materials for the pair of busbars 41 include a metal, such as Ag, Au, Cu, Pd, Pt, Ti, Cr, Ni, Al, Zr, W, V, Rh, Ir, or an alloy of any of the above; a metal oxide, such as ZnO, SnO₂, In₂O₃ (ITO), WO₃, Al₂O₃, Ga₂O₅, TiO₂, or Ta₂O₅; or a combination of any of the above. The pair of busbars 41 may each be a laminated film.

There is no particular limitation on the ratio of the thickness of the busbars 41 to the thickness of the light transmissive plate-like member 31 (the thickness of busbars/the thickness of light transmissive plate-like member), and the ratio is preferably 0.05 or less or more preferably 0.02 or less.

There is no particular limitation on the thickness of the busbars 41, and the thickness is preferably 20 μm or less, more preferably 15 μm or less, or particularly preferably 10 μm or less. The lower limit of the thickness of the busbars 41 is preferably 5 μm or more preferably 6 μm.

There is no particular limitation on the method of forming the busbars 41. Each busbar 41 can be formed, for example, by printing a conductive paste containing one or more types of conductive particles on the mounting surface 10S of the light shielding treatment glass plate 10 and by heating the conductive paste. For the conductive paste, a copper paste containing copper particles and an organic binder, a silver paste containing silver particles and an organic binder, or the like is preferable.

A terminal 61 is attached to each of the busbars 41, as necessary.

The plan-view shape of each terminal 61 and the positions on the busbars 41 at which the terminals 61 are attached can be designed, as appropriate, within a range in which the terminals 61 do not interfere with the mounting of an optical device.

In the illustrated example, each terminal 61 is attached to the corresponding busbar 41 in a portion located outside the light transmissive plate-like member 31. As viewed in a plan view, it suffices that each terminal 61 be located at least partially on the corresponding busbar 41, and a portion of each terminal 61 may lie outside the corresponding busbar 41.

The terminals 61 can be attached to the respective busbars 41 through a known method, and the terminals 61 are preferably fixed with solder, for example.

In general, in a light shielding treatment glass plate, a light shielding treatment portion having a light shielding layer is comparatively thicker than a light transmitting portion having no light shielding layer. Furthermore, in a thermoforming process of a glass plate, a black light shielding treatment portion absorbs a larger amount of heat than a light transmitting portion and thus has a higher temperature. Owing to these factors, unevenness arises around the border between the light shielding treatment portion and the light transmitting portion in the light shielding treatment glass plate. Such unevenness may cause perspective distortion around the border between the light shielding treatment portion and the light transmitting portion, and this perspective distortion may lead to distortion of an image obtained by an optical device.

In the glass structure 1 of the present embodiment, the light transmissive plate-like member 31 that is thinner than the light shielding treatment glass plate 10 is mounted on the mounting surface 10S for an optical device on the light shielding treatment glass plate 10 with the bonding film 20 interposed therebetween so as to cover the light transmitting portion TP and a portion of the light shielding treatment portion BP. Therefore, as shown in FIGS. 3A and 3B, unevenness around the border between the light shielding treatment portion BP and the light transmitting portion TP of the light shielding treatment glass plate 10 can be reduced, perspective distortion around the border between the light shielding treatment portion BP and the light transmitting portion TP of the light shielding treatment glass plate 10 can be suppressed, and an image obtained by an optical device can be kept from being distorted.

The presence or the level of perspective distortion can be evaluated, for example, based on the distortion of a pattern observed when a zebra pattern is viewed through the glass structure.

In the window glass for vehicle described in International Patent Publication No. WO2014/157535 cited in the section “Background Art,” inside the laminated glass constituting the windshield, the electric heating film is formed on substantially the entire surface, and the busbars are formed each in a belt shape at the upper and lower end portions.

In the present embodiment, the one or more electric heating wires 32L may be formed not on the light shielding treatment glass plate 10 having a large area but on the light transmissive plate-like member 31 having a small area. Therefore, the region in which the one or more electric heating wires 32L are formed can be kept small, and the one or more electric heating wires 32L can be formed in a simple manner and at low cost in a process separate from the manufacturing of the light shielding treatment glass plate 10.

In the present embodiment, the pair of busbars 41 are formed on the mounting surface 10S of the light shielding treatment glass plate 10. The region in which the pair of busbars 41 are formed can be designed small, along with the region in which the one or more electric heating wires 32L are formed on the light transmissive plate-like member 31. Therefore, the pair of busbars 41 can be formed also in a simple manner and at low cost.

In the present embodiment, the pair of busbars 41 are formed on the mounting surface 10S of the light shielding treatment glass plate 10. Therefore, unlike in the case in which a pair of busbars 41 are formed on the light transmissive plate-like member 31, the light transmissive plate-like member 31 is unlikely to become distorted due to the presence of the pair of busbars 41 in, for example, the process of firing a tentative stack.

In the present embodiment, the pair of busbars 41 are formed on the mounting surface 10S of the light shielding treatment glass plate 10. Therefore, unlike in the case in which a pair of busbars 41 are formed on the light transmissive plate-like member 31, the terminals 61 can be formed on the busbars 41 with ease.

In the window glass for vehicle described in International Patent Publication No. WO2014/157535, wires need to be drawn out from the pair of busbars formed inside the laminated glass constituting the windshield and formed, as viewed in a plan view, at the upper and lower end portions of the windshield. In this case, the wires need to be drawn out from the busbars onto the inner surface side or the outer surface side via a side surface of the windshield. Then, the drawing of the wires becomes circuitous, and the appearance is not very aesthetic.

In the present embodiment, the one or more electric heating wires 32L are formed on the light transmissive plate-like member 31, and the pair of busbars 41 are formed near the one or more electric heating wires 32L. This configuration provides a high design flexibility in the position at which the light transmissive plate-like member 31 is mounted on the light shielding treatment glass plate 10 and in the positions at which the pair of busbars 41 are formed on the light shielding treatment glass plate 10. Therefore, the design of how wires are drawn out from the busbars 41 can be highly flexible, and the manner in which wires are drawn out from the busbars 41 can be designed with good aesthetic appearance.

Unlike in the window glass for vehicle described in International Patent Publication No. WO2014/157535, in which the electric heating film and the pair of busbars are enclosed inside the laminated glass, in the glass structure 1 of the present embodiment, a condensation surface can be heated directly by the one or more electric heating wires 32L formed on the light transmissive plate-like member 31. Thus, a high anti-fogging performance can be obtained, and this is preferable.

There is no particular limitation on the plan-view distance between the light transmitting portion TP and the busbars 41. From the standpoint of preventing perspective distortion around the busbars, the shortest plan-view distance between the light transmitting portion TP and the busbars 41 is preferably 3 mm or more. From the standpoint of securing the field of view, the upper limit of the shortest plan-view distance between the light transmitting portion TP and the busbars 41 is preferably 20 mm.

As described thus far, according to the present embodiment, perspective distortion around the border between the light shielding treatment portion and the light transmitting portion can be suppressed, the electric heating wires and the busbars can be formed in a simple manner and at low cost, and the glass structure 1 with a high flexibility in the design of how wires are drawn out from the busbars can be provided.

### [Method of Manufacturing Glass Structure of First Embodiment]

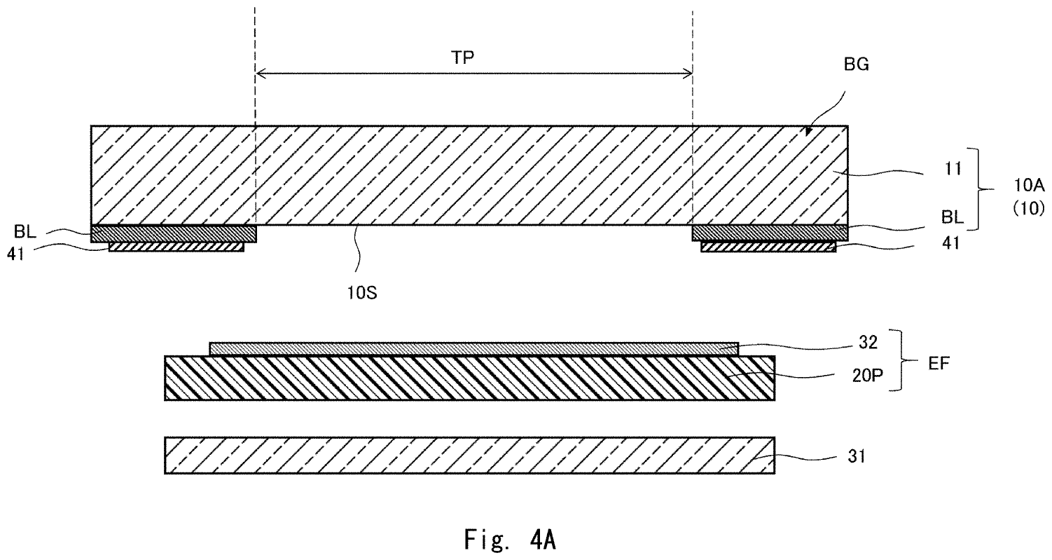

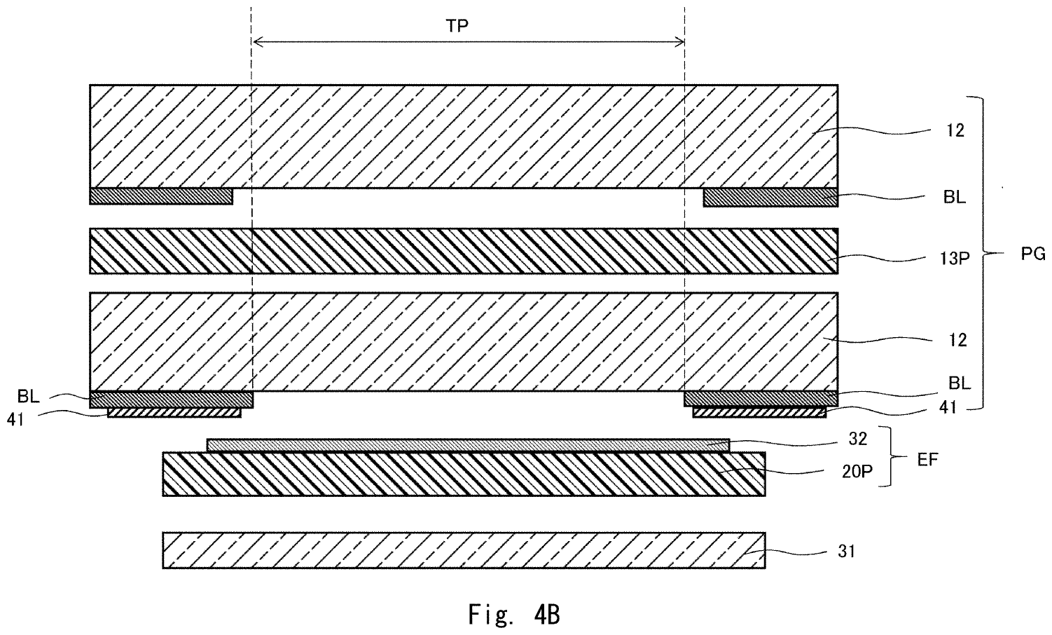

As shown in FIG. 4A, a method of manufacturing a glass structure of the first embodiment according to the present invention includes
a step (S11) of preparing a light shielding treatment glass plate with busbars BG in which a pair of busbars 41 are formed on a light shielding treatment glass plate 10,
a step (S12) of preparing a resin film with a conductive pattern film EF in which a conductive pattern film 32 is formed on a resin film 20P for bonding,
a step (S13) of preparing a light transmissive plate-like member 31, and
a step (S14) of stacking the light shielding treatment glass plate with busbars BG, the resin film with the conductive pattern film EF, and the light transmissive plate-like member 31 and bonding the light shielding treatment glass plate with busbars BG, the resin film with the conductive pattern film EF, and the light transmissive plate-like member 31 through thermocompression bonding.

### (Step (S11))

A light shielding treatment glass plate 10 is prepared. A light shielding treatment tempered glass 10A in which a light shielding layer BL is formed on a portion of a surface of a tempered glass 11, such as the one shown in FIG. 3A, or a light shielding treatment laminated glass 10B in which a light shielding layer BL is formed on a portion of the inside and/or a surface of a laminated glass composed of a plurality of glass plates 12 affixed to each other with an intermediate film 13 interposed therebetween, such as the one shown in FIG. 3B, is prepared. The method of forming the light shielding layer BL has been described above, and thus the description is omitted here.

A light shielding treatment glass plate with busbars BG, such as the one shown in FIG. 4A, is prepared by forming a pair of busbars 41 on a mounting surface 10S of the light shielding treatment tempered glass 10A or of the light shielding treatment laminated glass 10B. Furthermore, terminals 61 are formed on the respective busbars 41, as necessary. The methods of forming the pair of busbars 41 and the terminals 61 have been described above, and thus the description is omitted here.

FIG. 4A is a schematic sectional view corresponding to FIG. 3A. FIG. 4A shows a case in which the light shielding treatment glass plate 10 is a light shielding treatment tempered glass 10A.

### (Step (S12))

Separately, as shown in FIG. 4A, a resin film with a conductive pattern film EF is prepared by forming a conductive pattern film 32 on a resin film 20P for bonding. The method of forming the conductive pattern film 32 has been described above, and thus the description is omitted here.

### (Step (S13))

Separately, as shown in FIG. 4A, a light transmissive plate-like member 31 is prepared.

The order of the step (S11), the step (S12), and the step (S13) is not particularly limited, and a plurality of steps among these steps may be performed simultaneously.

### (Step (S14))

The light shielding treatment glass plate with busbars BG, the resin film with the conductive pattern film EF, and the light transmissive plate-like member 31 prepared as shown in FIG. 4A are stacked together to obtain a tentative stack.

The light transmissive plate-like member 31 is disposed so as to cover the light transmitting portion TP and a portion of the light shielding treatment portion BP of the light shielding treatment glass plate 10.

The resin film with the conductive pattern film EF is disposed between the light shielding treatment glass plate with busbars BG and the light transmissive plate-like member 31 such that the side of the resin film with the conductive pattern film EF where the conductive pattern film 32 is located faces the light shielding treatment glass plate with busbars BG and the side where the resin film 20P is located faces the light transmissive plate-like member 31. The resin film with the conductive pattern film EF is disposed between the light shielding treatment glass plate with busbars BG and the light transmissive plate-like member 31 such that a portion of the conductive pattern film 32 is in contact with the busbars 41.

The obtained tentative stack is bonded through thermocompression bonding. At this step, as the resin film 20P is softened and pressed, the softened resin spreads between the one or more electric heating wires 32L and the light shielding treatment glass plate 10, and the light shielding treatment glass plate 10 and the light transmissive plate-like member 31 become bonded to each other with a bonding film 20 interposed therebetween, as shown in FIG. 3A.

The thermocompression bonding can be performed through a known method. Examples of thermocompression bonding techniques include a method in which a tentative stack is placed in a bag made of rubber or the like and heated in vacuum; a method in which a tentative stack is pressed and heated with use of an automatic pressing and heating treatment apparatus, an autoclave, or the like; or a combination of the above.

There is no particular limitation on the conditions of the thermocompression bonding, such as the temperature, the pressure, or the duration, and these conditions are designed in accordance with the temperature and the type of the resin film 20P for bonding. The conditions of the thermocompression bonding may be set such that the resin film is softened and pressed sufficiently and the light shielding treatment glass plate 10 and the light transmissive plate-like member 31 are sufficiently bonded with the bonding film 20 interposed therebetween.

The thermocompression bonding may be performed in a plurality of stages with the methods or conditions varied.

For example, in one preferable method, a tentative stack is placed in a bag made of rubber or the like and heated to 70-100° C. in vacuum of −65-−100 kPa, and then pressed and heated under the condition that the temperature is about 100-150° C. and the pressure is about 0.6-1.3 MPa.

As the light shielding treatment glass plate 10 and the light transmissive plate-like member 31 are compression-bonded with the resin film 20P for bonding having been softened, any space in the light shielding layer BL on the surface of the light shielding treatment glass plate 10 is filled with the bonding film 20, and unevenness in the surface around the border between the light shielding treatment portion BP and the light transmitting portion TP of the light shielding treatment glass plate 10 is reduced. As a result, perspective distortion around the border between the light shielding treatment portion BP and the light transmitting portion TP of the light shielding treatment glass plate 10 is suppressed, and an image obtained by an optical device is kept from being distorted.

A glass structure 1, such as the one shown in FIG. 3A, is manufactured as described above.

### [Method of Manufacturing Glass Structure of Second Embodiment]

As shown in FIG. 4B, a method of manufacturing a glass structure of a second embodiment according to the present invention includes
a step (S21) of preparing a plurality of glass plates 12 having a light shielding layer BL formed on a portion of a surface of at least one of the plurality of glass plates 12 and having a pair of busbars 41 formed on a surface of one of the plurality of glass plates 12,
a step (S22) of preparing a resin film with a conductive pattern film EF in which a conductive pattern film 32 is formed on a resin film 20P for bonding,
a step (S23) of preparing a light transmissive plate-like member 31, and
a step (S24) of stacking a glass tentative stack PG obtained by stacking the plurality of glass plates 12 with a resin film 13P for bonding disposed between each glass plate, the resin film with the conductive pattern film EF, and the light transmissive plate-like member 31 such that the pair of busbars 41 are located at the outermost surface, and bonding the glass tentative stack PG, the resin film with the conductive pattern film EF, and the light transmissive plate-like member 31 through thermocompression bonding.

### (Step (S21))

As shown in FIG. 4B, a plurality of glass plates 12 having a light shielding layer BL formed on a portion of a surface of at least one of the plurality of glass plates 12 and having a pair of busbars 41 formed on a surface of one of the plurality of glass plates 12 are prepared. Terminals 61 are formed on the respective busbars 41, as necessary. The methods of forming the light shielding layer BL, the pair of busbars 41, and the terminals 61 have been described above, and thus the description is omitted here.

FIG. 4B is a schematic sectional view corresponding to FIG. 3B.

### (Step (S22))

Separately, as shown in FIG. 4B, a resin film with a conductive pattern film EF is prepared by forming a conductive pattern film 32 on a resin film 20P for bonding. The method of forming the conductive pattern film 32 has been described above, and thus the description is omitted here.

### (Step (S23))

Separately, as shown in FIG. 4B, a light transmissive plate-like member 31 is prepared.

The order of the step (S21), the step (S22), and the step (S23) is not particularly limited, and a plurality of steps among these steps may be performed simultaneously.

### (Step (S24))

As shown in FIG. 4B, the plurality of glass plates 12 are stacked together with the resin film 13P for bonding disposed between each glass plate and such that the pair of busbars 41 are located at the outermost surface, and thus a glass tentative stack PG is obtained. This glass tentative stack PG, the resin film with the conductive pattern film EF, and the light transmissive plate-like member 31 are stacked together to obtain a tentative stack. This tentative stack is bonded through thermocompression bonding.

The arrangement of the light transmissive plate-like member 31, the arrangement of the resin film with the conductive pattern film EF, and the conditions of the thermocompression bonding are similar to those at step (S14).

A glass structure 1, such as the one shown in FIG. 3B, is manufactured as described above.

In the method of manufacturing the glass structure of the second embodiment, the manufacturing of the laminated glass and the bonding of the light transmissive plate-like member 31 onto the laminated glass can be performed simultaneously, and this is preferable.

### EXAMPLES

The present invention will be described below based on examples, but these examples do not limit the present invention. Examples 1-1, 1-2, and 3 to 6 are working examples.

### [Evaluation Items And Evaluation Method]

### (Perspective Distortion)

A perspective distortion test was performed in compliant with JIS R 3212:2015 (5.12). The distance between a test piece and the screen was 4 m. The angle at which a test piece was attached relative to the horizontal line was 25 degrees. The evaluation was performed based on the following standards.

∘∘ (excellent): The maximum value of perspective distortion within the light transmitting portion (TP) was 1.5 arc minutes or less.

∘ (good, pass): The maximum value of perspective distortion within the light transmitting portion (TP) was no more than a threshold for a front window test region A (specifically, 2.0 arc minutes or less).

× (unacceptable): The maximum value of perspective distortion within the light transmitting portion (TP) was more than 2.0 arc minutes.

### Example 1-1

### (Step (S21))

As materials for a laminated glass, two flat glass plates (12) (having a square shape measuring 300 mm vertically by 300 mm horizontally, and a thickness of 2 mm) were prepared.

As shown in FIG. 4B, a paste containing black pigment and glass frit was applied to one of the surfaces of each of the two glass plates (12) in a region surrounding a center portion that would serve as a square-shaped light transmitting portion (TP) measuring 40 mm vertically by 40 mm horizontally, and the paste was heated to form a light shielding layer (BL).

Furthermore, as shown in FIG. 4B, a pair of busbars (41) were formed on the light shielding layer (BL) on one of the glass plates (12). The pair of busbars (41) were formed to the upper side and the lower side of the light transmitting portion (TP) with the light transmitting portion (TP) located therebetween, as viewed in a plan view. Each busbar (41) had a shape that was a combination of a belt-shaped portion (41A) and a substantially rectangular-shaped portion (41B), as shown in FIG. 2. The busbars (41) were formed by printing a copper paste containing copper particles and an organic binder to a predetermined region on the light shielding layer on the one of the glass plates (12) and by heating the copper paste. Each busbar had a thickness of 50 μm, and the belt-shaped portion of each busbar had a width of 10 mm.

The two glass plates (12) described above were thermoformed to be curved in the vertical direction. The radius of curvature of the curved concave surface in the vertical direction was 3,000 mm.

### (Step (S22))

As a material for a bonding film for bonding a light transmissive plate-like member (resin film (20P) for bonding), a polyvinyl butyral (PVB) film (thickness of 1 mm) was prepared. On this PVB film, a conductive pattern film (32) composed of a plurality of electric heating wires (32L) each having a wave line shape as viewed in a plan view shown schematically in FIG. 2 and a pair of belt-shaped busbar portions (32B) was formed. The plurality of electric heating wires (32L) were formed to meet the conditions that the linewidth was 10 μm, the thickness was 10 μm, and the pitch was 3 mm. Each busbar portion (32B) had a width of 10 mm. In this manner, a resin film with a conductive pattern film (EF), such as the one shown in FIG. 4B, was obtained.

### (Step (S23))

As a light transmissive plate-like member (31), a chemical tempered glass (having a square shape measuring 70 mm vertically by 70 mm horizontally, and a thickness of 1 mm) was prepared.

### (Step (S24))

As a material for an intermediate film of a laminated glass (resin film (13P) for bonding), a polyvinyl butyral (PVB) film (thickness of 0.76 mm) was prepared. As shown in FIG. 4B, the resin film (13P) for bonding was placed between the two curved glass plates (12) obtained at step (S21), and thus a glass tentative stack (PG) was obtained. As shown in FIG. 4B, the two curved glass plates (12) were disposed such that the pair of busbars (41) are located at the outermost surface.

As shown in FIG. 4B, the glass tentative stack (PG) described above, the resin film with the conductive pattern film (EF) obtained at step (S22), and the light transmissive plate-like member (31) prepared at step (S23) were stacked together.

The light transmissive plate-like member (31) was disposed so as to cover the light transmitting portion (TP) and a portion of the light shielding treatment portion (BP) of the light shielding treatment glass plate (10) and to cover the belt-shaped portion of each busbar (41) formed on the curved glass plate (12). In the example summarized in Tables 1 and 2, the width of the belt-shaped portion of each busbar (41) substantially matches the overlapping width (W) of the busbar (41) and the light transmissive plate-like member (31) on the light shielding treatment glass plate (10), as viewed in a plan view.

The resin film with the conductive pattern film (EF) was disposed between the glass tentative stack (PG) and the light transmissive plate-like member (31) such that the side of the resin film with the conductive pattern film (EF) where the conductive pattern film (32) was located faced the light shielding treatment glass plate with busbars (BG) and the side where the resin film (20P) was located faced the light transmissive plate-like member (31). The resin film with the conductive pattern film (EF) was disposed between the glass tentative stack (PG) and the light transmissive plate-like member (31) such that the busbar portions (32B) and end portions of the electric heating wires (32L) included in the conductive pattern film (32) were in contact with the busbars (41) formed on the curved glass plate (12).

The obtained tentative stack was bonded through thermocompression bonding. Specifically, the tentative stack was placed in a bag made of rubber or the like, heated to 110° C. in vacuum of −60 kPa, and then pressed and heated under the conditions that the temperature was 150° C. and the pressure was 1.3 MPa. Through these processes, the light transmissive plate-like member (31) was curved so as to follow the surface shape of the glass tentative stack (PG). The radius of curvature, in the vertical direction, of the curved concave surface of the light transmissive plate-like member (31) that had undergone thermocompression bonding was 3,000 mm.

In the manner described above, a glass structure was obtained. Main manufacturing conditions and evaluation results are shown in Table 1. In each example shown in Tables 1 and 2, conditions that are not indicated in the tables are shared conditions.

### Examples 1-2, 3 to 6

Glass structures were obtained in similar manners as Example 1-1, except that the conditions were changed to the conditions shown in Tables 1 and 2. Evaluation results are shown in Tables 1 and 2.

Abbreviations in Table 1 indicate the following.

PET: polyethylene terephthalate,

OCA: A stack, having a thickness of 1 mm, of a plurality optical clear adhesive sheets “LUCIACS (registered trademark) CS986 series manufactured by Nitto Denko Corporation.

TABLE 1

| | | Example 1-1 | | Example 1-2 | | Example 2 | |
|---|---|---|---|---|---|---|---|
| Laminated Glass | Radius of Curvature of | 3000 | mm | 3000 | mm | 3000 | mm |
| | Curved Concave Surface | | | | | | |
| Material for Intermediate Film | Type | PVB | | PVB | | PVB | |
| of Laminated Glass | Thickness | 0.76 | mm | 0.76 | mm | 0.76 | mm |
| Busbar | Surface Where Formed | Curved Concave | | Curved Concave | | Curved Concave | |
| | | Surface of | | Surface of | | Surface of | |
| | | Laminated Glass | | Laminated Glass | | Laminated Glass | |
| | Thickness | 50 | μm | 50 | μm | 50 | μm |
| | Width of Belt-Shaped | 10 | mm | 10 | mm | 10 | mm |
| | Portion | | | | | | |
| Light Transmissive Plate-Like Member | Type | Chemical Tempered | | PET | | Chemical Tempered | |
| | | Glass | | | | Glass | |
| | Thickness | 1 | mm | 1 | mm | 1 | mm |
| | Radius of Curvature of | 3000 | mm | 3000 | mm | 3000 | mm |
| | Curved Concave Surface | | | | | | |
| Thickness of Busbar/Thickness of Light Transmissive | | 0.05 | | 0.05 | | 0.05 | |
| Plate-Like Member [—] | | | | | | | |
| Material for Bonding Film for Bonding | Type | PVB | | OCA | | PVB | |
| Light Transmissive Plate-Like Member | Thickness | 1 | mm | 1 | mm | 0.1 | mm |

| | | | |
|---|---|---|---|
| Perspective Distortion | 1.8 arc minutes | 2.0 arc minutes | 1.3 arc minutes |
| | ◯ | ◯ | ◯◯ |

TABLE 2

| | | Example 3 | | Example 4 | | Example 5 | | Example 6 | |
|---|---|---|---|---|---|---|---|---|---|
| Laminated Glass | Radius of Curvature of | 3000 | mm | 3000 | mm | 3000 | mm | 3000 | mm |
| | Curved Concave Surface | | | | | | | | |
| Material for Intermediate Film | Type | PVB | | PVB | | PVB | | PVB | |
| of Laminated Glass | Thickness | 0.76 | mm | 0.76 | mm | 0.76 | mm | 0.76 | mm |
| Busbar | Surface Where Formed | Curved Concave | | Curved Concave | | Curved Concave | | Curved Concave | |
| | | Surface of | | Surface of | | Surface of | | Surface of | |
| | | Laminated Glass | | Laminated Glass | | Laminated Glass | | Laminated Glass | |
| | Thickness | 50 | μm | 50 | μm | 50 | μm | 50 | μm |
| | Width of Belt-Shaped | 2 | mm | 15 | mm | 10 | mm | 10 | mm |
| | Portion | | | | | | | | |
| Light Transmissive Plate-Like Member | Type | Chemical | | Chemical | | Chemical | | Chemical | |
| | | Tempered Glass | | Tempered Glass | | Tempered Glass | | Tempered Glass | |
| | Thickness | 1 | mm | 1 | mm | 1 | mm | 1 | mm |
| | Radius of Curvature of | 3000 | mm | 3000 | mm | 1000 | mm | 20000 | mm |
| | Curved Concave Surface | | | | | | | | |
| Thickness of Busbar/Thickness of Light Transmissive | | 0.05 | | 0.05 | | 0.05 | | 0.05 | |
| Plate-Like Member [—] | | | | | | | | | |
| Material for Bonding Film for Bonding | Type | PVB | | PVB | | PVB | | PVB | |
| Light Transmissive Plate-Like Member | Thickness | 0.1 | mm | 0.1 | mm | 0.1 | mm | 0.1 | mm |

| | | | | |
|---|---|---|---|---|
| Perspective Distortion | 2.0 arc minutes | 1.7 arc minutes | 1.8 arc minutes | 1.9 arc minutes |
| | ◯ | ◯ | ◯ | ◯ |

### [Summary of Results]

In each of Examples 1-1, 1-2, and 3 to 6,
a glass structure in which
a light transmissive plate-like member that was thinner than a light shielding treatment glass plate was bonded to a curved concave surface of a light shielding treatment glass plate (corresponding to a mounting surface for an optical device) with a bonding film interposed therebetween so as to cover a light transmitting portion and a portion of a light shielding treatment portion,
a conductive pattern film including a plurality of electric heating wires was provided between the light shielding treatment glass plate and the light transmissive plate-like member,
the plurality of electric heating wires were formed in the bonding film, and
a pair of busbars were formed on the mounting surface of the light shielding treatment glass plate was obtained.

The obtained glass structures had small perspective distortion and were good.

The above embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A glass structure comprising:
a light shielding treatment glass plate including an optical device mounting region on which an optical device is to be mounted, a light transmitting portion that is located within the optical device mounting region and through which light entering the optical device from the outside and/or light emitted from the optical device passes, and a light shielding treatment portion that surrounds at least a portion of the light transmitting portion;
a light transmissive plate-like member that is thinner than the light shielding treatment glass plate and is mounted on a mounting surface for the optical device on the light shielding treatment glass plate so as to cover the light transmitting portion and a portion of the light shielding treatment portion; and
a conductive pattern film including one or more electric heating wires, the conductive pattern film being formed between the light shielding treatment glass plate and the light transmissive plate-like member, wherein
the light transmissive plate-like member is bonded to the light shielding treatment glass plate with a bonding film interposed therebetween,
the electric heating wires are formed in the bonding film, and
a pair of busbars for feeding electricity to the one or more electric heating wires are formed on the mounting surface of the light shielding treatment glass plate.

2. The glass structure according to claim 1, wherein
a portion of each of the busbars overlaps the light transmissive plate-like member, as viewed in a plan view, and
at least a portion of each of the one or more electric heating wires is in contact with the busbars.

3. The glass structure according to claim 1, wherein
a portion of each of the busbars overlaps the light transmissive plate-like member, as viewed in a plan view,
the conductive pattern film includes the one or more electric heating wires and a pair of busbar portions, and
at least a portion of each of the busbar portions included in the conductive pattern film is in contact with the busbars on the light shielding treatment glass plate.

4. The glass structure according to claim 1, wherein a terminal is attached to each of the pair of busbars on the light shielding treatment glass plate.

5. The glass structure according to claim 1, wherein the light shielding treatment glass plate is a laminated glass having a light shielding layer formed on a portion of an inside and/or a surface thereof or a tempered glass having a light shielding layer formed on a portion of a surface thereof.

6. The glass structure according to claim 1, wherein the light shielding treatment glass plate is a laminated glass having a light shielding layer formed on a portion of an inside and/or a surface thereof, and the bonding film has a thickness smaller than a thickness of an intermediate film in the laminated glass.

7. The glass structure according to claim 1, wherein the light transmissive plate-like member is composed of a glass and/or a resin.

8. The glass structure according to claim 1, wherein the bonding film has a thickness of 0.02-1 mm.

9. The glass structure according to claim 1, wherein a ratio of a thickness of the busbars to a thickness of the light transmissive plate-like member is 0.05 or less.

10. The glass structure according to claim 2, wherein an overlapping width of each of the busbars and the light transmissive plate-like member on the light shielding treatment glass plate is 2-15 mm, as viewed in a plan view.

11. The glass structure according to claim 1, wherein the light transmissive plate-like member has a thickness of 1 mm or less.

12. The glass structure according to claim 1, wherein an inner surface of the light shielding treatment glass plate and an inner surface of the light transmissive plate-like member each have a radius of curvature of 1,000-20,000 mm.

13. A method of manufacturing the glass structure according to claim 1, the method comprising:
a step (S11) of preparing a light shielding treatment glass plate with busbars in which the pair of busbars are formed on the light shielding treatment glass plate;
a step (S12) of preparing a resin film with a conductive pattern film in which the conductive pattern film is formed on a resin film for bonding;
a step (S13) of preparing the light transmissive plate-like member; and
a step (S14) of stacking the light shielding treatment glass plate with busbars, the resin film with the conductive pattern film, and the light transmissive plate-like member and bonding the light shielding treatment glass plate with busbars, the resin film with the conductive pattern film, and the light transmissive plate-like member through thermocompression bonding.

14. A method of manufacturing the glass structure according to claim 1, the light shielding treatment glass plate being a laminated glass having a light shielding layer formed on a portion of an inside and/or a surface thereof, the method comprising:
a step (S21) of preparing a plurality of glass plates having the light shielding layer formed on a portion of a surface of at least one of the plurality of glass plates and having the pair of busbars formed on a surface of one of the plurality of glass plates;
a step (S22) of preparing a resin film with a conductive pattern film in which the conductive pattern film is formed on a resin film for bonding;
a step (S23) of preparing the light transmissive plate-like member; and
a step (S24) of stacking a glass tentative stack obtained by stacking the plurality of glass plates with a resin film for bonding disposed between each glass plate, the resin film with the conductive pattern film, and the light transmissive plate-like member such that the pair of busbars are located at an outermost surface, and bonding the glass tentative stack, the resin film with the conductive pattern film, and the light transmissive plate-like member through thermocompression bonding.
